(19) United States
(12) Patent Application Publication
(10) Pub. No.: US 2026/0100624 A1
(43) Pub. Date: Apr. 9, 2026

(54) SHAFT GROUND RING

(71) Applicant: HYUNDAI MOBIS CO., LTD., Seoul (KR)

(72) Inventor: Yeong Woo SEO, Yongin-si (KR)

(73) Assignee: HYUNDAI MOBIS CO., LTD., Seoul (KR)

(21) Appl. No.: 19/350,558

(22) Filed: Oct. 6, 2025

(30) Foreign Application Priority Data
Oct. 7, 2024 (KR) 10-2024-0135339

(51) Int. Cl. H02K 11/40

(52) U.S. Cl. CPC H02K 11/40

(57) ABSTRACT

The present invention relates to a shaft ground ring for preventing bearing electrical erosion caused by leakage current, and more specifically, the shaft ground ring of the present invention includes a brush that contacts the outer circumferential surface of the shaft to discharge leakage current flowing through the shaft to the outside, and a pair of cases disposed opposite each other relative to the brush so as to enclose the brush, wherein the shaft ground ring, by reducing the number of components, facilitates the manufacture and assembly of the components, and further includes a flow path through which cooling fluid can pass.

The present application claims priority to Korean Patent Application No. 10-2024-0135339, filed October 7, 2024, the entire contents of which is incorporated herein for all purposes by this reference.

### BACKGROUND OF THE INVENTION

### Field of the Invention

The present invention relates to a shaft ground ring for preventing bearing electrical erosion caused by leakage current generated in an electric motor.

### Description of the Related Art

In recent years, electric vehicles have gained significant attention due to various factors, including environmental protection, interest in renewable energy, and energy efficiency. An electric vehicle is typically equipped with an electric motor as a driving source that generates rotational power from electrical energy in place of a conventional internal combustion engine.

The electric motor may include a housing, a stator fixedly installed inside the housing, and a rotor that rotates around a shaft serving as a drive shaft. In general, the electric motor is driven by a pulse-width modulation (PWM) method through inverter switching. In such a configuration, shaft voltage may be induced in the shaft, and leakage current of the electric motor may flow along the shaft, generating voltage spikes and causing bearing electrical erosion that damages the bearing surface.

As the electric motor serves as the primary driving source of the electric vehicle, the problem of bearing electrical erosion has become increasingly significant. Bearing electrical erosion may cause damage to the bearing itself or reduce its service life, and furthermore, may result in damage to the electric motor, a reducer, and other components due to bearing failure.

While operating voltages of electric motors have been continuously increased to enhance performance, such increases promote bearing electrical erosion. Methods for preventing bearing electrical erosion include blocking the flow of current or discharging the current externally through a grounding system. Among these, a shaft ground ring (SGR) is a component disposed in contact with the shaft at a location proximate to the bearing, which prevents bearing electrical erosion by allowing current flowing through the shaft to be discharged externally through the housing.

However, conventional shaft ground rings have limitations in that they comprise numerous components, each having a relatively high material cost, and the complexity of these components results in increased manufacturing costs. In addition, conventional shaft ground rings may include structures that obstruct the flow of cooling fluid along the shaft, thereby degrading cooling performance.

### SUMMARY OF THE INVENTION

The present invention has been conceived to address the above problems, and it is an object of the present invention to provide a shaft ground ring capable of preventing bearing electrical erosion, which, unlike conventional structures, has a simpler, more manufacturable configuration to reduce material costs and facilitate production, and forms a flow path for cooling fluid to improve the cooling performance of the electric motor.

A shaft ground ring attached to a shaft of an electric motor to block leakage current according to the present invention includes a brush contacting the outer circumferential surface of the shaft to discharge leakage current flowing through the shaft to the outside, and a pair of cases arranged to face each other with respect to the brush, the pair of cases enclosing the brush.

In addition, the brush and the cases are formed in an annular shape.

In addition, the brush and the cases are formed in a “C”-shape defining a partial circumference of a predetermined length.

In addition, the case includes at least one coupling portion including a pin protruding toward the brush and a hole recessed to correspond to the pin, the coupling portion being arranged along the circumference.

In addition, the pair of cases are arranged to face each other on opposite sides of the brush, and the pin of the coupling portion on one case is fitted into the hole of the coupling portion on the opposing case, and the cases are assembled by press-fitting.

In addition, the case includes at least one through-hole formed along the circumference of the case to allow flow through the case.

In addition, the case includes a recessed portion formed to a predetermined depth along an inner circumferential surface on a surface in contact with the brush, the recessed portion accommodating a portion of the outer circumference of the brush.

In addition, the case further includes at least one through-hole formed through the case along an outer circumferential surface.

In addition, the case further includes at least one coupling portion, excluding the area of the through-hole along the outer circumferential surface, the coupling portion including a pin protruding toward the brush and a hole recessed to correspond to the pin.

In addition, the brush is formed of at least one of conductive rubber, conductive carbon, or conductive fabric, and the case is formed of a metal material.

### BRIEF DESCRIPTION OF THE DRAWINGS

FIG. 1 is a partial cross-sectional view of an electric motor in which a conventional shaft ground ring is installed;

FIG. 2 is an exploded perspective view of the conventional shaft ground ring;

FIG. 3 is a partial perspective view of an electric motor in which a shaft ground ring according to an embodiment of the present invention is installed;

FIG. 4 is a cross-sectional view of an electric motor in which a shaft ground ring according to an embodiment of the present invention is installed;

FIG. 5 is a perspective view illustrating the overall structure of the shaft ground ring according to an embodiment of the present invention;

FIG. 6 is an exploded perspective view of the shaft ground ring according to an embodiment of the present invention;

FIG. 7 is a perspective view of a shaft ground ring according to another embodiment of the present invention;

FIG. 8 is an exploded perspective view illustrating the overall structure of a shaft ground ring according to another embodiment of the present invention;

FIG. 9 is a side view of a coupling portion of the shaft ground ring according to the present invention; and

FIG. 10 is a conceptual diagram illustrating the flow of operating fluid generated by the shaft ground ring according to an embodiment of the present invention.

### DETAILED DESCRIPTION OF THE INVENTION

In the following, the technical aspects of the present invention will be described in more detail with reference to the accompanying drawings. Prior to this, the terms and words used in the following specification and claims should not be construed in a limited sense to their usual or dictionary meanings but should be interpreted according to the meanings and concepts that conform to the technical ideas of the present invention, based on the principle that the inventor can appropriately define the terms to best describe their invention.

Therefore, the embodiments described in this specification and the configurations shown in the drawings are merely the most preferred embodiments of the present invention and do not fully represent the technical concept of the present invention, so it should be understood that various modifications and equivalents that can replace them may exist at the time of filing this application.

In the following, the technical aspects of the present invention will be described in more detail with reference to the accompanying drawings. The accompanying drawings illustrate examples provided solely to more specifically explain the technical spirit of the present invention, and the technical spirit of the present invention is not limited to the configurations shown in the accompanying drawings.

The present invention relates to a shaft ground ring 100 for preventing electrical erosion of a bearing 2 caused by leakage current in an electric motor, wherein the shaft ground ring 100 may be a component disposed in contact with a shaft 1 at a position adjacent to the bearing 2 and configured to discharge the leakage current flowing through the shaft 1 to the outside via a housing 3.

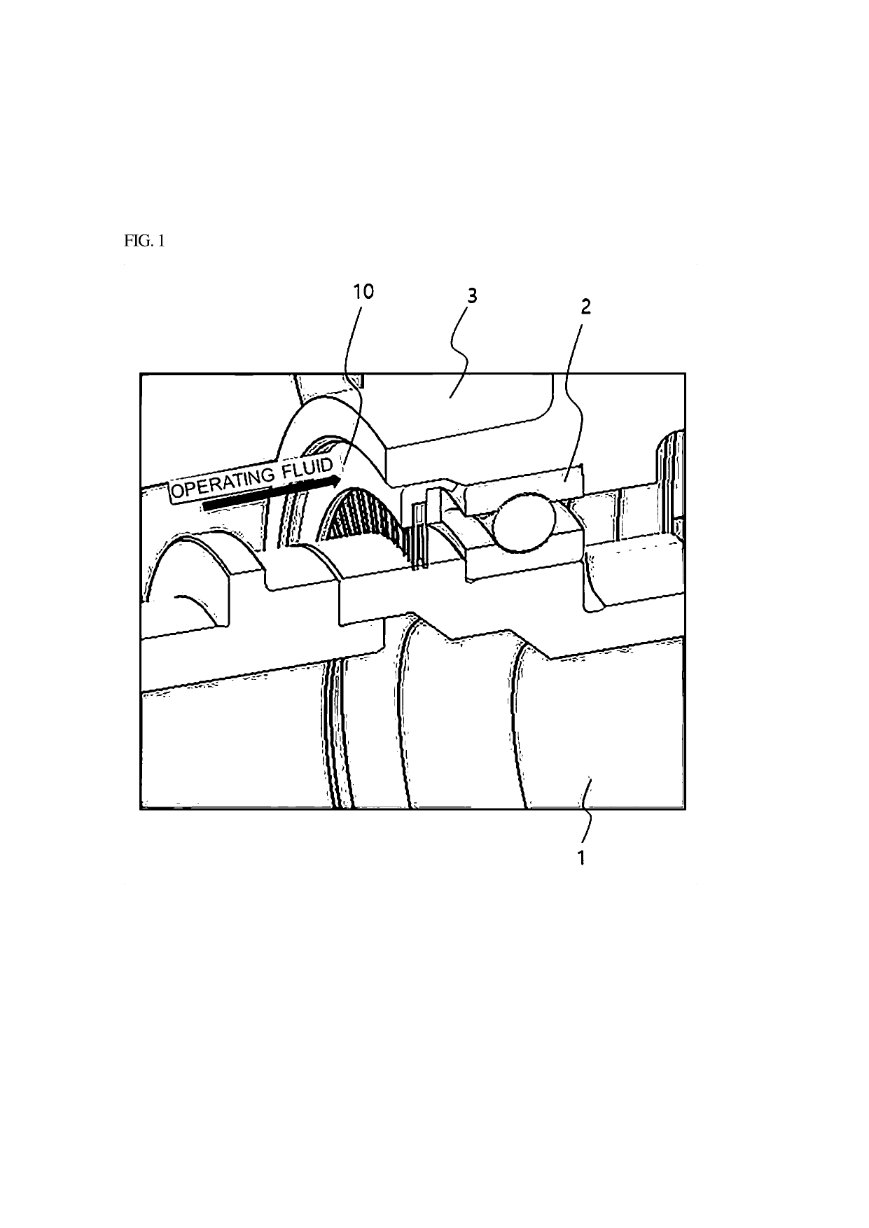

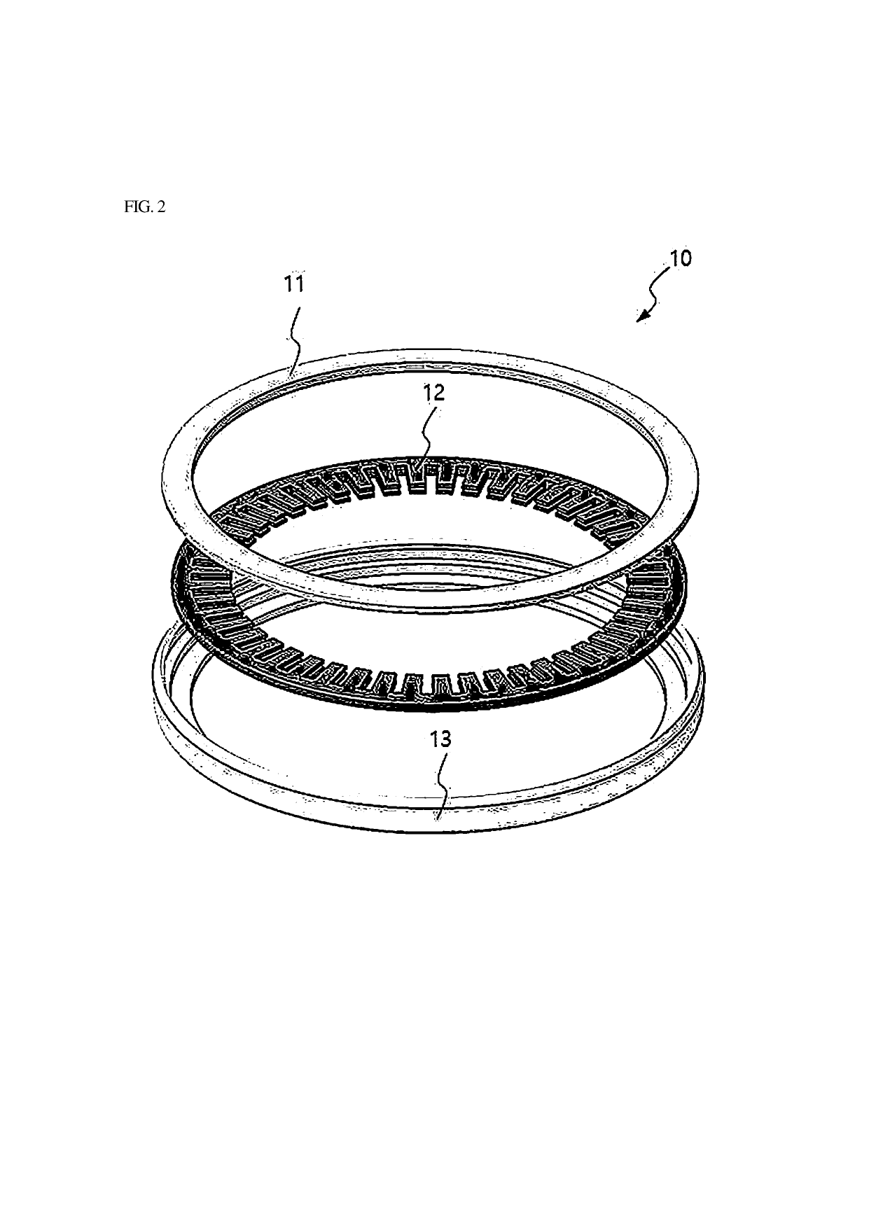

Referring to FIGS. 1 and 2, a conventional shaft ground ring 10 generally includes a brush 12, which is in direct contact with the shaft 1 and serves to conduct current, a case 13 in which the brush 12 is seated and which is assembled to the electric motor housing 3, and a cover 11 press-fitted into the case 13 to secure the brush 12. Here, the case 13 and the cover 11 are formed in different shapes to perform different functions. Since the conventional shaft ground ring 100 is assembled from three components of different shapes, it has many parts, resulting in a complex manufacturing process and relatively high cost, which limits its broad applicability. In addition, the cover 11 and the case 13 block the space between the shaft 1 and the housing 3, partially obstructing the flow of cooling fluid in the electric motor and thereby reducing cooling performance.

The shaft ground ring 100 of the present invention is designed to solve the above problems and is characterized by reducing the number of components and configuring each component for ease of manufacture, thereby simplifying production and reducing cost. In addition, by forming a flow path that allows cooling fluid to pass, the shaft ground ring 100 of the present invention improves cooling performance compared to conventional designs.

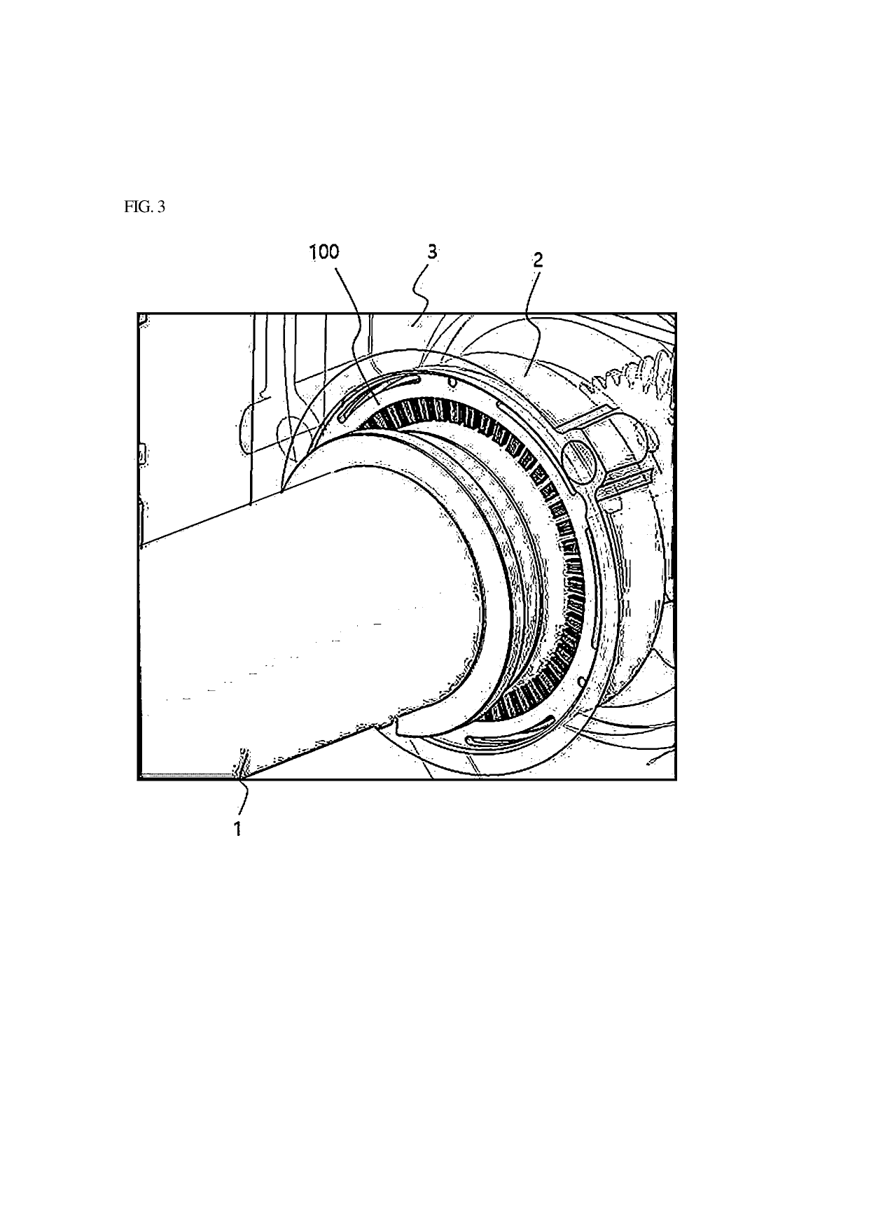

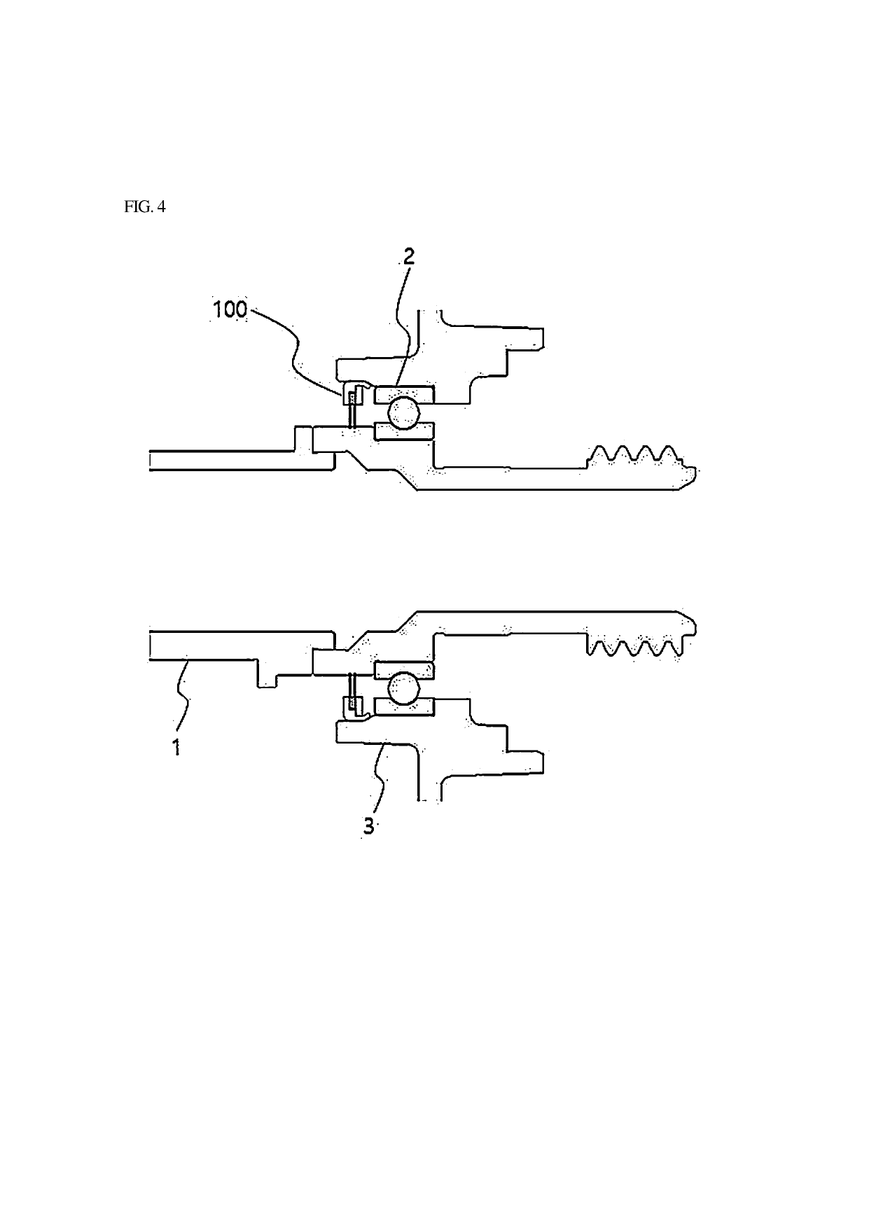

Referring to FIGS. 3 and 4, the shaft ground ring 100 of the present invention, which is mounted on a shaft 1 of an electric motor to block leakage current, includes a brush 120 that is in contact with the outer circumferential surface of the shaft 1 to discharge leakage current flowing through the shaft 1 to the outside, and a pair of cases 110 arranged opposite each other relative to the brush 120 and surrounding the brush 120.

The shaft ground ring 100 of the present invention is a component configured to discharge leakage current generated in the electric motor to the housing 3 through the brush 120, and, as illustrated in FIGS. 3 and 4, is formed to contact the shaft 1 to allow the leakage current flowing through the shaft 1 to be discharged externally via the brush 120. The brush 120 is preferably formed of a conductive material to transmit current flowing through the shaft 1, and since the brush 120 contacts the rotating outer circumferential surface of the shaft 1, it may be formed of a softer material to prevent surface damage. According to an embodiment of the present invention, the brush 120 is preferably formed of a soft yet conductive material, such as conductive rubber obtained by mixing black pigment or metal fibers into insulating rubber, conductive carbon fibers formed by the same or a different method, or conductive fabric, so as to provide electrical conductivity while maintaining a soft surface.

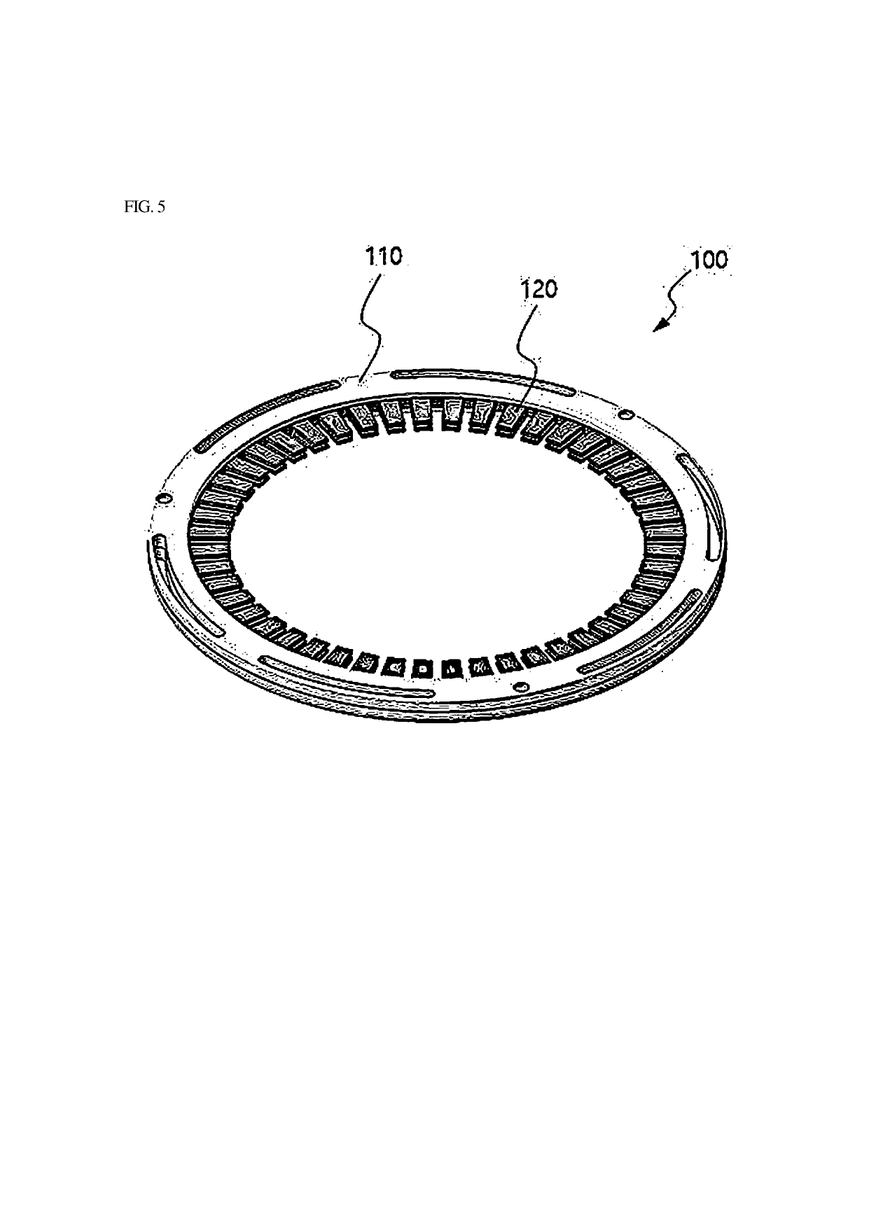

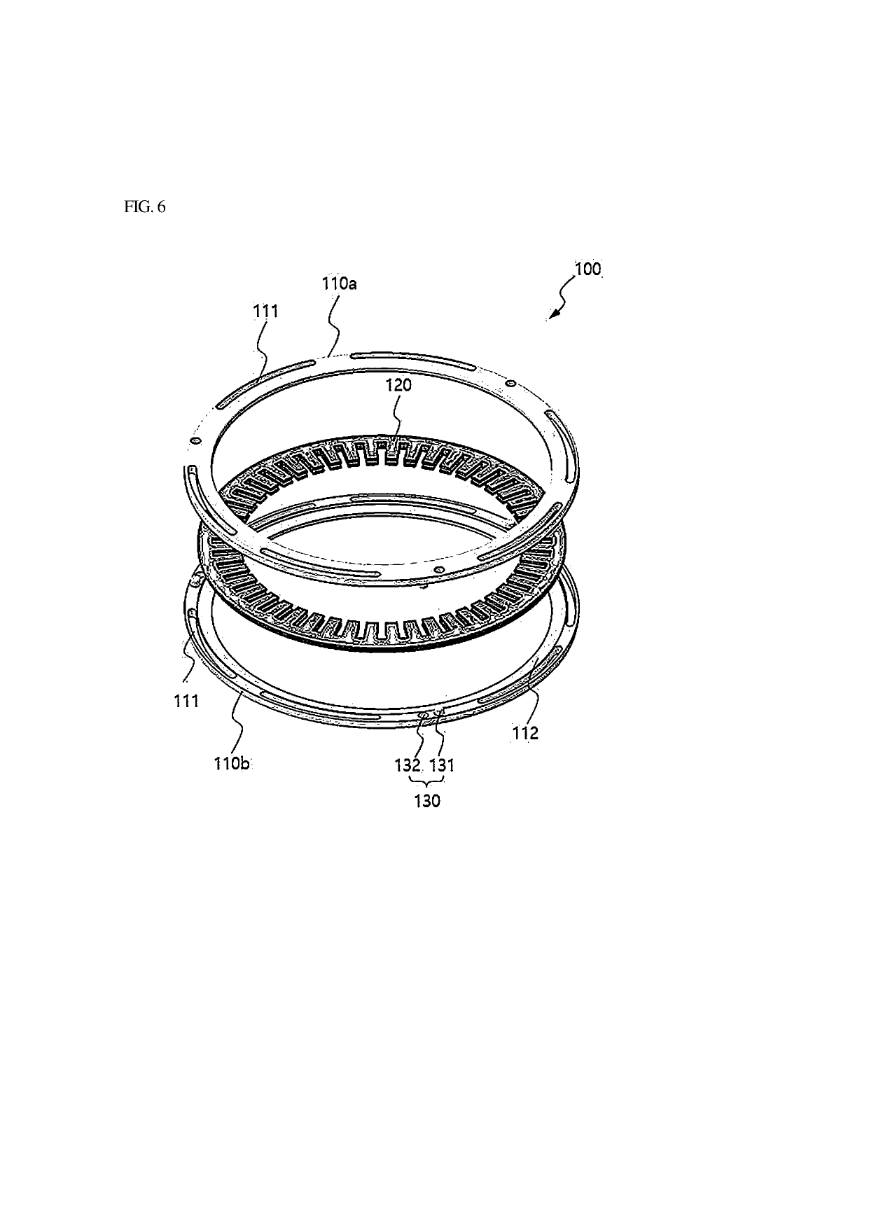

Referring to FIGS. 5 and 6, the shaft ground ring 100 of the present invention is implemented by assembling a pair of cases 110, each having the same shape and accommodating the brush 120 while connecting the brush 120 to the electric motor housing 3. The case 110 is composed of a first case 110a and a second case 110b, which are formed in the same shape but arranged to face each other relative to the brush 120. In other words, the first case 110a and the second case 110b, which have identical shapes, are positioned on opposite sides of the brush 120 to face each other, and by combining the first case 110a and the second case 110b, the case 110 enclosing the brush 120 is formed.

Through this configuration, the shaft ground ring 100 can be manufactured by forming only the brush 120 and the first case 110a and the second case 110b, thereby reducing the number of components compared to conventional designs. Furthermore, since the first case 110a and the second case 110b have identical shapes, the case 110 can be manufactured using a single production device, thereby simplifying both the manufacturing and assembly processes of the shaft ground ring 100.

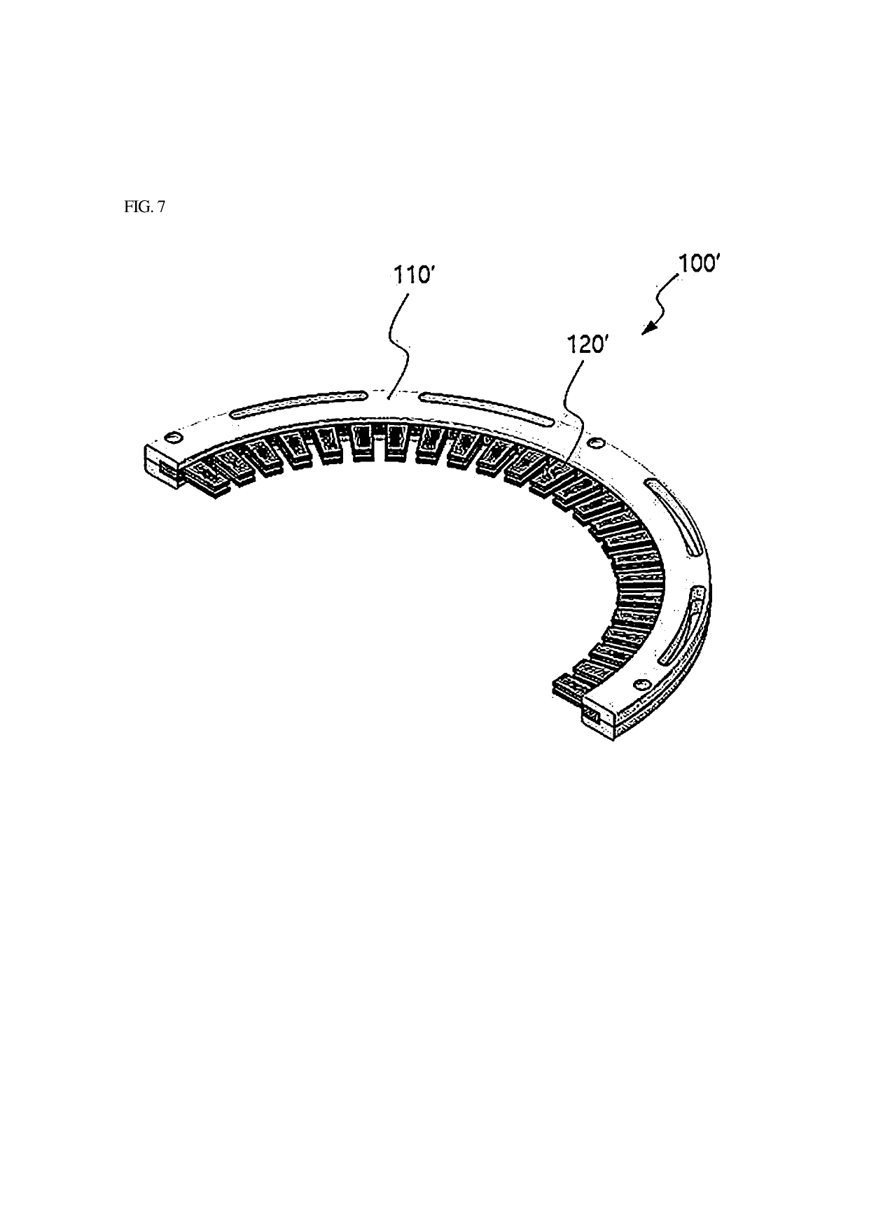

Referring to FIGS. 6 and 7, the case 110 preferably connects the brush 120 to the electric motor housing 3, and is configured to conduct the current transmitted through the brush 120 to the housing 3. That is, the case 110 is preferably arranged to contact both the brush 120 and the housing 3. The case 110 is preferably formed of a conductive material capable of transmitting current, and may be made of a relatively rigid material to serve as a housing 3 that seats and fixes the position of the brush 120. According to an embodiment of the present invention, the case 110 may be formed of a metallic material.

The shaft ground ring 100 of the present invention may be mounted on the electric motor as a component. According to an embodiment, the shaft ground ring 100 is formed in an annular shape and may be assembled onto the outer circumferential surface of the shaft 1. Accordingly, as illustrated in FIGS. 6 and 7, the brush 120 and the case 110 constituting the shaft ground ring 100 are characterized by an annular shape. Since the inner circumferential surface of the brush 120 contacts the shaft 1, the inner diameter of the brush 120 is preferably equal to or greater than the outer diameter of the shaft 1. By forming the shaft ground ring 100 in an annular shape, it can be more stably mounted on the electric motor.

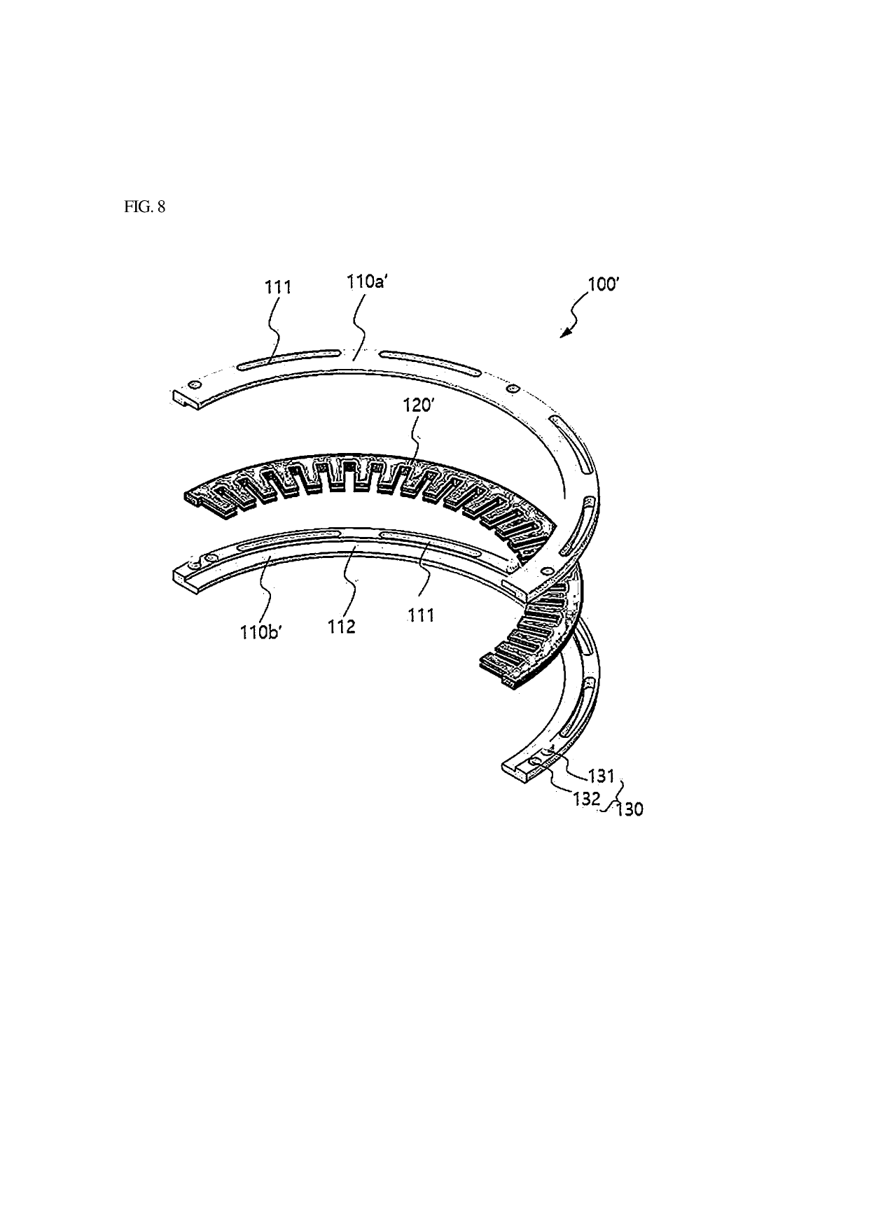

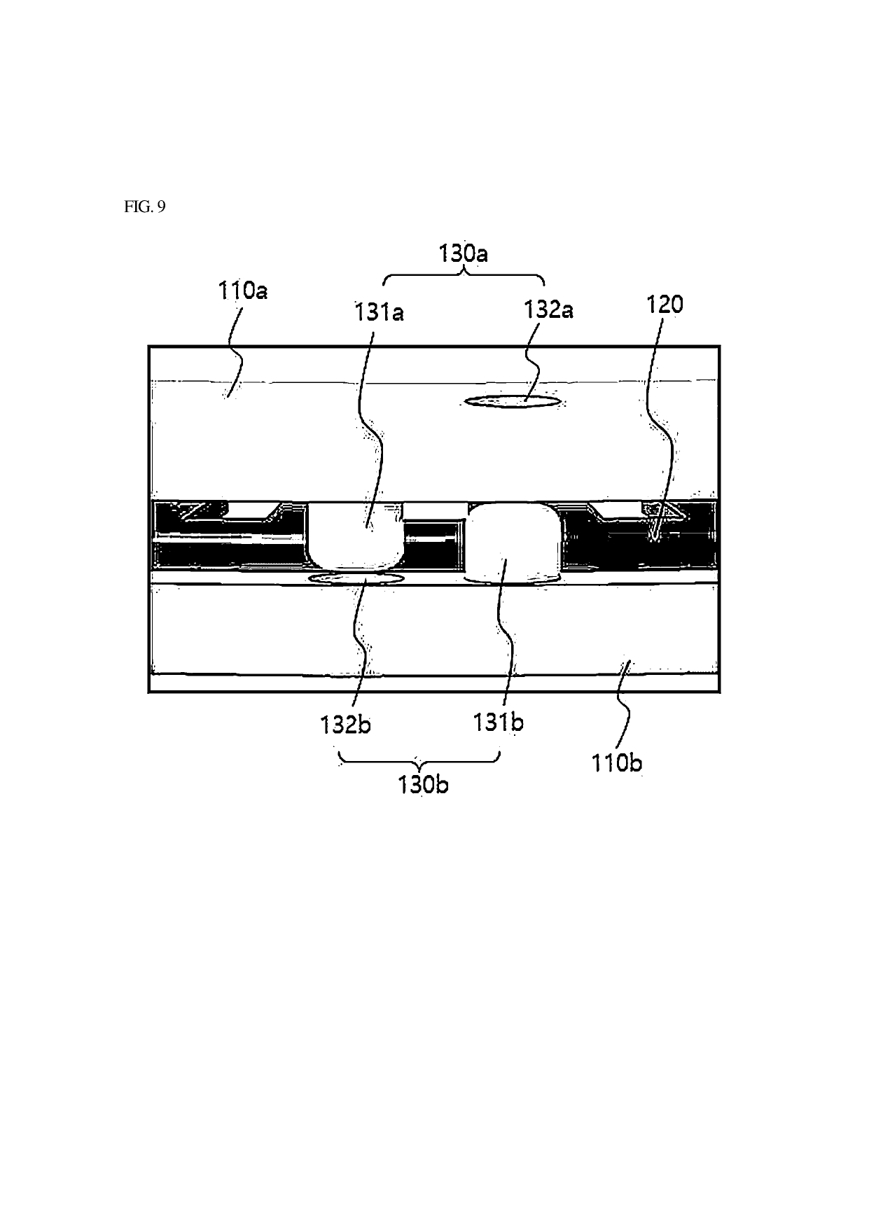

Referring to FIGS. 8 and 9, the shaft ground ring 100′ according to another embodiment of the present invention is characterized by a “C”-shape forming a partial circumference. In other words, the shaft ground ring 100′ is configured in a curved shape that contacts only a portion of the circumference of the shaft 1. Accordingly, the brush 120′ and the case 110′ constituting the shaft ground ring 100′ are also characterized by a C-shaped curve of a predetermined length. Since the brush 120′ only needs to sufficiently contact the shaft 1 to conduct leakage current, the C-shaped design of the shaft ground ring 100′ provides adequate performance while reducing material costs. The curvature of the shaft ground ring 100′ is preferably matched to the curvature of the shaft 1, and the length of the curve may be set to a minimum sufficient to transmit current, considering the characteristics of the brush 120′.

The case 110 of the present invention is configured as a pair having identical shapes. To form the shaft ground ring 100, the brush 120 and the case 110 need to be assembled together. The present invention is characterized in that the case 110 includes a coupling means, and when a pair of cases 110 are assembled to face each other, they are coupled by the coupling means formed on the cases 110. As illustrated in FIGS. 6, 8, and FIG. 9, the case 110 includes a coupling portion 130, which has a pin 131 protruding toward the brush 120 arranged along the circumference, and a hole 132 recessed to correspond to the pin 131. In particular, as shown in FIGS. 6 and 8, the coupling portion 130 is formed on the case 110, and in the pair of cases 110 arranged to face each other, the coupling portion 130 may be formed on the inner surfaces where the cases 110 contact each other. Here, the inner surface may correspond to the portion of the case 110 that contacts the brush 120. The coupling portion 130 is configured as a set of the protruding pin 131 and the recessed hole 132, and the pins 131 and holes 132 are arranged side by side along the circumference of the case 110. The coupling portion 130 may be formed at one or more locations on the case 110, depending on the circumferential length of the case 110 or as necessary. In other words, to ensure a more robust coupling between the cases 110, a plurality of coupling portions 130 may be arranged considering their area.

A method of assembling a pair of cases 110 using the coupling portions 130 will be described in further detail with reference to FIG. 9. The pair of cases 110 may include a first case 110a and a second case 110b, which have identical shapes and are arranged to face each other on opposite sides of the brush 120, contacting each respective side of the brush 120. The first case 110a and the second case 110b each include the same number and shape of coupling portions 130. When the first case 110a and the second case 110b, each having coupling portions 130, are positioned to face each other, the pins 131 and holes 132 of the coupling portions 130 are aligned in opposing positions. In this state, by assembling the first case 110a and the second case 110b to contact each other, the coupling portions 130a of the first case 110a and the coupling portions 130b of the second case 110b are interlocked and assembled. That is, the pin 131a of the coupling portion 130a of the first case 110a is inserted into the hole 132b of the coupling portion 130b of the second case 110b, or vice versa, the pin 131b of the coupling portion 130b of the second case 110b is inserted into the hole 132a of the coupling portion 130a of the first case 110a, or vice versa thereby assembling the cases 110 and the brush 120. This assembly method, using cases 110 formed in identical shapes, reduces the number of components required to construct the shaft ground ring 100, simplifying both the manufacturing and assembly processes while providing ease of assembly.

The case 110 is configured to fix the brush 120 and preferably includes a portion within which the brush 120 can be seated. Referring to FIGS. 6 and 8, the case 110 of the present invention includes a recessed portion 112 formed along the inner circumferential surface of the case 110 at the inner surface area contacting the brush 120, having a predetermined thickness and height. Here, the inner surface may correspond to the portion of the case 110 that contacts the brush 120. The recessed portion 112 is configured to accommodate the brush 120, and at least a portion of the outer circumference of the brush 120 is received within the recessed portion 112. That is, the outer circumferential portion of the brush 120 contacts the inner circumferential surface of the case 110 and is seated therein. The recessed portion 112 may have a depth approximately half the thickness of the brush 120 and is recessed from the inner surface area of the case 110. Furthermore, the recessed portion 112 is formed along the inner circumferential surface of the case 110, with its height determined according to the width of the brush 120 to be accommodated, and may occupy half or more, or less than half, of the width of the case 110.

In addition, the shaft ground ring 100 of the present invention is characterized by including a flow path through which cooling fluid can pass. The shaft ground ring 100 contacts and couples with the housing 3 of the electric motor at the outer circumferential surface of the shaft 1. In the case of a conventional shaft ground ring 100, the space between the shaft 1 and the housing 3 is blocked, which hinders the flow of cooling fluid and results in reduced cooling performance. To address this issue, the shaft ground ring 100 of the present invention is configured such that the case 110 includes at least one through-hole 111 of a predetermined length formed along the circumference of the case 110.

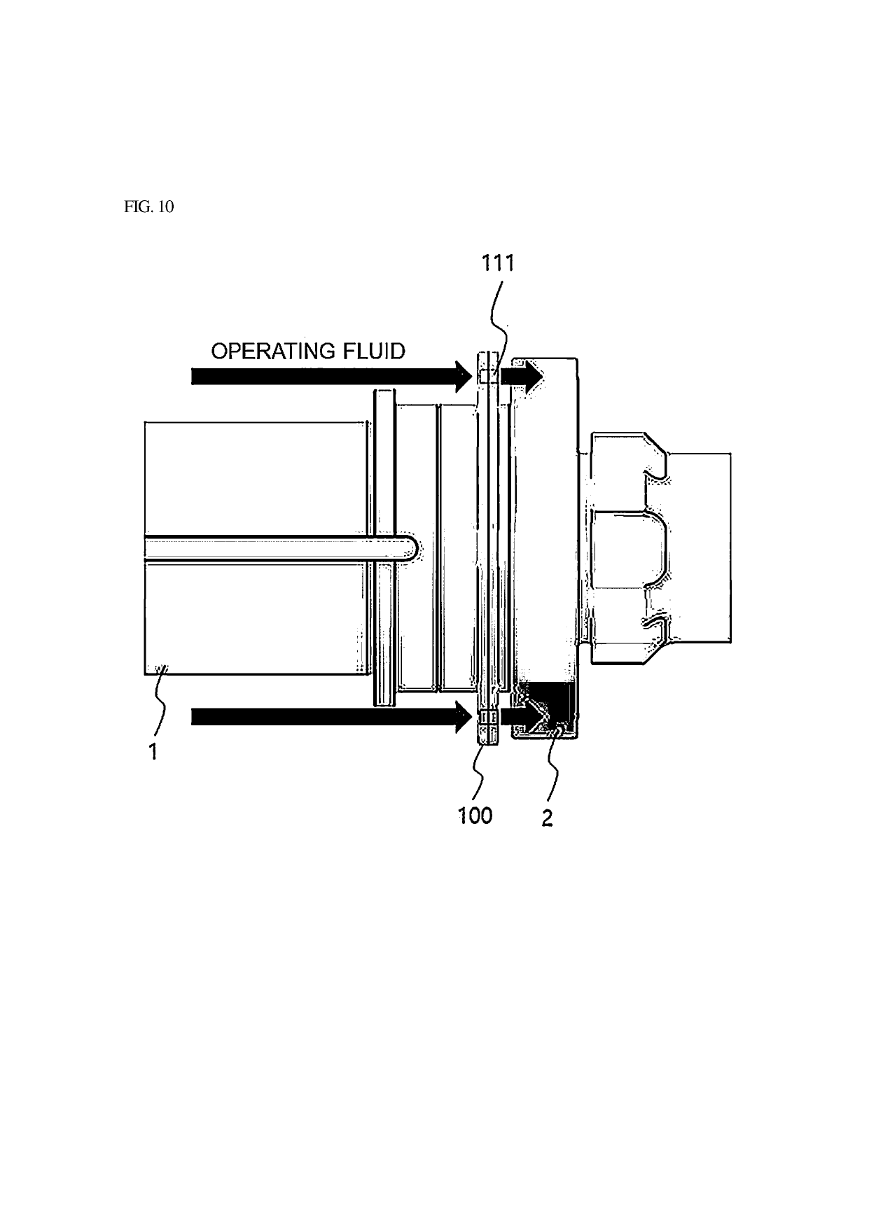

Referring to FIGS. 6, 8, and 10, the through-hole 111 is a hole formed in the case 110 in a direction parallel to the longitudinal direction of the shaft 1, through which cooling fluid can flow. The through-hole 111 may have a circular cross-section of a predetermined area and a predetermined length along the circumference of the case 110, and its shape and number may be adjusted, as necessary. Since the brush 120 is mounted on the inner circumferential surface of the case 110, it is preferable that the through-hole 111 for fluid flow be formed along the outer circumferential surface of the case 110. In other words, at least one through-hole 111 is disposed in the outer portion of the recessed portion 112 that accommodates the brush 120. The case 110 also includes a coupling portion 130. Preferably, the coupling portion 130 is formed at the portion where a pair of cases 110 come into contact, and therefore is preferably formed in areas excluding the portion accommodating the brush 120. Accordingly, the coupling portion 130 may be formed on the outer portion of the recessed portion 112 and arranged in areas excluding the through-hole 111. That is, along the outer circumferential surface of the case 110, at least one coupling portion 130 and at least one through-hole 111 may be provided, and they may be arranged at required positions along the circumference of the case 110 so as not to overlap with each other.

The shaft ground ring of the present invention having the above configuration is advantageous in effectively grounding and discharging leakage current generated in the shaft to prevent bearing electrical erosion, thereby reducing bearing wear and damage, extending the maintenance cycle and service life of the electric motor, providing a simpler, more manufacturable structure with fewer components to reduce costs, enabling assembly and installation without additional costly or complex devices for application to high-capacity electric motors, and improving the cooling performance of the electric motor through a flow path that allows cooling fluid to pass.

As described above, although the present invention has been explained with reference to specific components and limited embodiments illustrated in the drawings, this explanation is provided solely to facilitate a better understanding of the invention, and the invention is not limited to the illustrated embodiments, as those skilled in the art may make various modifications and variations based on this disclosure.

Therefore, the spirit of the present invention is not confined to the described embodiments, and all elements encompassed by the appended claims, as well as any equivalents or variations thereof, fall within the scope of the invention.

### DESCRIPTION OF REFERENCE NUMERALS

1: shaft

2: bearing

3: case

4: shaft ground ring

110: case

111: through-hole

112: recessed portion

120: brush

130: coupling portion

131: pin

132: hole

What is claimed is:

1. A shaft ground ring attached to a shaft of an electric motor to block leakage current, the shaft ground ring comprising:
a brush contacting an outer circumferential surface of the shaft to discharge leakage current flowing through the shaft to the outside; and
a pair of cases disposed to face each other with respect to the brush, the pair of cases enclosing the brush.

2. The shaft ground ring of claim 1, wherein the brush and the cases are formed in an annular shape.

3. The shaft ground ring of claim 1, wherein the brush and the cases are formed in a “C”-shape defining a partial circumference of a predetermined length.

4. The shaft ground ring of claim 1, wherein one case among the pair of the cases comprises at least one coupling portion including a pin protruding toward the brush and the other case among the pair of the cases comprises at least one coupling portion including a hole recessed to correspond to the pin, the at least one coupling portion of the one case and the at least one coupling portion of the other case being disposed along the circumference of the shaft ground ring.

5. The shaft ground ring of claim 4, wherein the pair of cases are disposed to face each other on opposite sides of the brush, and the pin of the at least one coupling portion on the one case is fitted into the hole of the at least one coupling portion on the other case, and the cases are assembled by press-fitting.

6. The shaft ground ring of claim 1, wherein each case comprises at least one through-hole formed along the circumference of each case to allow flow through each case.

7. The shaft ground ring of claim 1, wherein each case comprises a recessed portion formed to a predetermined depth along an inner circumferential surface of each case on a surface in contact with the brush, the recessed portion accommodating a portion of an outer circumference of the brush.

8. The shaft ground ring of claim 7, wherein each case further comprises at least one through-hole formed through each case along an outer circumferential surface of each case.

9. The shaft ground ring of claim 8, wherein each case further comprises at least one coupling portion, excluding an area of the at least one through-hole along the outer circumferential surface, the at least one coupling portion comprising a pin protruding toward the brush and a hole recessed in the at least one coupling portion.

10. The shaft ground ring of claim 9, wherein the pin of the at least one coupling portion on the one case among the pair of the cases is fitted into the hole of the at least one coupling portion on the other case, and wherein the pin of the at least one coupling portion on the other case among the pair of the cases is fitted into the hole of the at least one coupling portion on the one case.

11. The shaft ground ring of claim 1, wherein the brush is formed of at least one of conductive rubber, conductive carbon, or conductive fabric, and each case is formed of a metal material.

12. An electric motor including a shaft, a housing, a stator disposed in the housing, and a rotor, the motor comprising:
the shaft ground ring of claim 1, contacting with the shaft.
